(19) United States
(12) Patent Application Publication
(10) Pub. No.: US 2026/0029080 A1
(43) Pub. Date: Jan. 29, 2026

(54) EXTENDED THREAD PROTECTOR FOR PERFORATING GUNS

(71) Applicant: HARRISON JET GUNS II, L.P., Kennedale, TX (US)

(72) Inventors: James F. Shelton, Kennedale, TX (US); Michael Crutcher, Kennedale, TX (US)

(21) Appl. No.: 18/997,846

(22) PCT Filed: Jul. 20, 2023
(86) PCT No.: PCT/US2023/028246

§ 371 Date: Jan. 23, 2025

Related U.S. Application Data
(60) Provisional application No. 63/393,318, filed on Jul. 29, 2022.

(51) Int. Cl. F16L 57/00; E21B 43/116

(52) U.S. Cl. CPC F16L 57/005; E21B 43/116

(57) ABSTRACT

An extended thread protector for a perforating gun is provided. The thread protector can be joined to a perforating gun to prevent material from entering the interior of the perforating gun while also protecting the threads of the perforating gun. The extended thread protector includes an extended cavity to accept various product classifications. In one embodiment, the thread protector includes an externally threaded collar and an extended sidewall that are separated from each other by a circumferential flange. The extended sidewall is slightly tapered along its outer diameter, narrowing toward the closed end of the thread protector. The extended sidewall is at least twice the length of the threaded collar, optionally between two and six times the length of the threaded collar.

### CROSS-REFERENCE TO RELATED APPLICATIONS

This application claims the benefit of U.S. Provisional Patent Application 63/393,318, filed Jul. 29, 2022, the disclosure of which in incorporated by reference in its entirety.

### TECHNICAL FIELD

The present invention relates to an extended thread protector for sealing the threaded end portion of perforating guns used to generate entrance holes in wellbore casings.

### BACKGROUND

In oil and gas operations, gun strings include a repeating series of perforating guns and tandems that are threaded end-to-end for insertion into a wellbore. When connecting a perforating gun to a tandem, this threaded engagement will determine the strength and seal quality of the resulting gun string. For this reason, it is vitally important to protect the thread profile of each perforating gun during its storage, handling, and transport.

Thread protectors are commonly used to guard against damage, moisture, and corrosion. Thread protectors typically include a tubular body having a cylindrical sidewall and at least one open end. The cylindrical sidewall is externally threaded to match the thread pattern of the threaded box end of a perforating gun. By affixing the thread protector onto the perforating gun, the thread profile of the perforating gun can be protected from moisture or debris (e.g., dirt or grime) prior to use at a well site.

Despite their advantages, there remains a continued need for an improved thread protector. In particular, there remains a continued need for an improved thread protector that protects the thread profile of a perforating gun during storage, transport, and handling, while also serving other functions.

### SUMMARY OF THE INVENTION

An extended thread protector for a perforating gun is provided. The thread protector can be joined to a perforating gun to prevent material from entering the interior of the perforating gun while also protecting the threads of the perforating gun. The extended thread protector also includes an extended cavity to accept various product classifications.

In one embodiment, the thread protector includes an externally threaded collar and an extended sidewall that are separated from each other by a circumferential flange. The extended sidewall is slightly tapered along its outer diameter, narrowing toward the closed end of the thread protector. The extended sidewall is at least twice the length of the threaded collar, optionally between two and six times the length of the threaded collar.

The closed end of the thread protector includes an end wall defining a recessed socket for a removal tool. An interior-facing surface of the end wall includes a plurality of reinforcing ribs, the reinforcing ribs being spaced apart from each other at equal intervals. The tool opening is a square-shaped opening in the present embodiment, but can include other shapes in other embodiments, for example a hexagonal opening.

In use, the thread protector is rotated relative to a perforating gun in a clockwise direction to secure the thread protector to the perforating gun. When the threads of the perforating gun are protected by the thread protector, the perforating gun may be stored or transported to a well site. When it is desired to assemble the perforating gun to a tandem as part of a gun string, the thread protector can be rotated relative to the perforating gun in a counter-clockwise direction to unlock and remove the thread protector.

These and other features and advantages of the present invention will become apparent from the following description of the invention, when viewed in accordance with the accompanying drawings and appended claims.

Before embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a side view of an extended thread protector.

FIG. 2 is a first end view of the extended thread protector of FIG. 1.

FIG. 3 is a second end view of the extended thread protector of FIG. 1.

FIG. 4 is a cross-sectional view of the extended thread protector of FIG. 1.

### DETAILED DESCRIPTION

The following detailed description is merely exemplary in nature and is not intended to limit the oilfield perforating systems and methods as described herein. Furthermore, there is no intention to be bound by any theory presented in the preceding background or the following detailed description. The description is not in any way meant to limit the scope of any present or subsequent related claims.

As used here, the terms “above” and “below”; “up” and “down”; “upper” and “lower”; “upwardly” and “downwardly”; and other like terms indicating relative positions above or below a given point or element are used in this description to more clearly describe some embodiments. However, when applied to equipment and methods for use in wells that are deviated or horizontal, such terms may refer to a left to right, right to left, or diagonal relationship as appropriate.

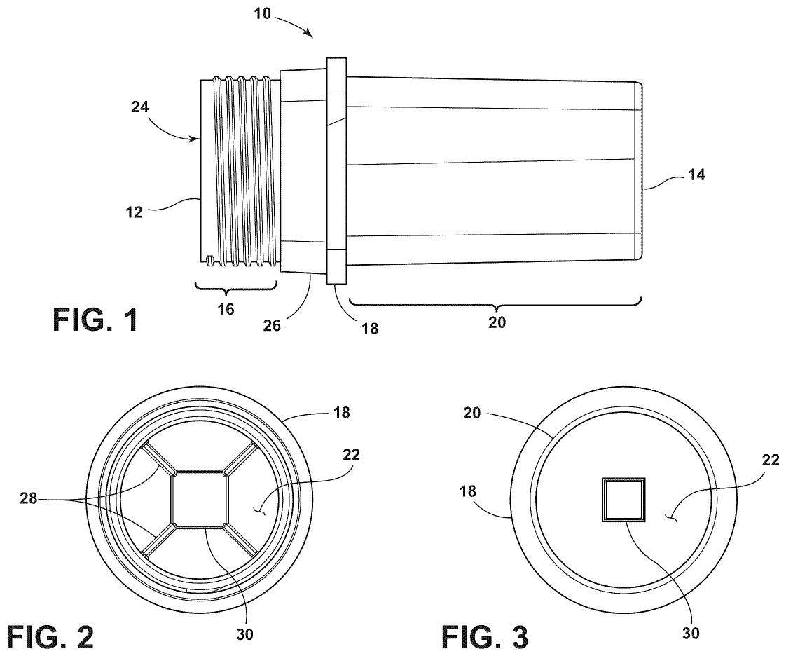

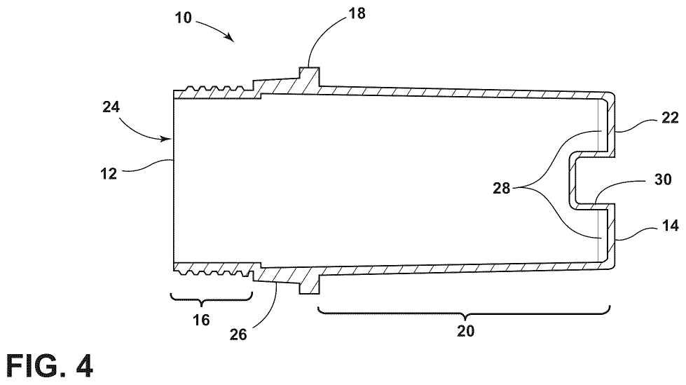

An extended thread protector in accordance with an exemplary embodiment is illustrated in FIGS. 1-4 and generally designated 10. The extended thread protector 10 may be releasably secured to the end of a tubular member, for example a perforating gun, to prevent material (e.g., moisture, dirt, grime) from entering the bore of the tubular member. In this manner, the extended thread protector protects the threads on the inner surface of the tubular member that may occur due to contact from moisture or debris.

In the embodiment shown, the extended thread protector 10 includes an open first end 12 that is opposite of a closed second end 14. The thread protector 10 includes an externally threaded collar 16 adjacent to the first end 12. The threaded collar 16 includes a thread profile that matches the thread profile of a perforating gun. A circumferential flange 18 separates the threaded collar 16 from an extended sidewall 20, the extended sidewall 20 being slightly tapered along length, narrowing toward the second end 14. An intermediate sidewall 26 is disposed between the threaded collar 16 and the circumferential flange 18.

As shown in FIGS. 2-4, the closed second end of the thread protector 10 includes reinforced end wall 22. The end wall 22 prevents debris from entering the central passage of the perforating gun. The internal cavity 24 extends from the open first end 12 to the closed second end 14 and is bordered by the threaded collar 16, the intermediate sidewall 26, and the extended sidewall 20. The axial length of the extended sidewall 20 is at least twice the axial length of the threaded collar 16, optionally between 2.0 and 6.0 times the axial length of the threaded collar 16, and the distance from the flange 18 to the closed second end 14 is between 2.0 and 6.0 times the distance from the flange 18 to the open first end 12.

The reinforced end wall 22 includes a plurality of reinforcing ribs 28 that are visible in FIG. 2, the reinforcing ribs 22 being spaced apart from each other at equidistant angular intervals. In the illustrated embodiment, four reinforcing ribs are shown at ninety-degree intervals, however greater or fewer reinforcing ribs 28 can be used as desired. As also shown, the end wall 22 includes a recessed socket opening 30 for a removal tool. The socket opening 30 protrudes into the internal cavity 24 and includes four sidewalls that are joined at a base. The socket opening 30 is a square-shaped opening in the present embodiment, but can include other shapes in other embodiments, for example a hexagonal opening.

In use, the thread protector 10 is rotated relative to a perforating gun in a clockwise direction to secure the thread protector 10 to the perforating gun. When the threads of the perforating gun are protected by the thread protector 10, the perforating gun may be stored or transported to a well site. When it is desired to assemble the perforating gun to a tandem as part of gun string, for example, the thread protector 10 can be rotated relative to the perforating gun in a counter-clockwise direction to unlock and remove the thread protector 10.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A thread protector comprising:
an externally threaded collar for threaded attachment to a perforating gun;
an extended sidewall that is separated from the externally threaded collar by a circumferential flange, wherein the extended sidewall defines a length that is at least twice a length defined by the externally threaded collar; and
an end wall including a recessed socket, wherein the recessed socket is keyed for a removal tool, and wherein the end wall includes a plurality of reinforcing ribs.

2. The thread protector of claim 1, wherein the length of the extended sidewall is between two and six times the length of the externally threaded collar.

3. The thread protector of claim 1, wherein the extended sidewall is frusto-conical along its length.

4. The thread protector of claim 1, wherein the recessed socket is defined by four planar side walls and a rectangular end wall.

5. The thread protector of claim 1, wherein each of the plurality of reinforcing ribs extend radially toward a corner portion of the recessed socket.

6. The thread protector of claim 1, wherein the extended sidewall is cylindrical and includes an outer diameter that narrows in the direction of the end wall.

7. The thread protector of claim 1, wherein the recessed socket is centrally disposed within the end wall.

8. The thread protector of claim 1, wherein the inner diameter of the extended sidewall is not less than the inner diameter of the threaded collar.

9. The thread protector of claim 1, further including an intermediate sidewall disposed between the threaded collar and the circumferential flange.

10. The thread protector of claim 1, wherein the circumferential flange defines a maximum outer diameter of the thread protector.

11. A thread protector for threaded attachment to a perforating gun, the threaded collar comprising:
an externally threaded collar;
an extended sidewall, wherein the extended sidewall is tapered, the extended sidewall defining a length that is at least twice a length defined by the externally threaded collar;
a circumferential flange disposed between the externally threaded collar and the extended sidewall; and
an end wall joined to the extended sidewall to define an interior cavity, the end wall including a recessed socket that is keyed for a removal tool, wherein the recessed socket is fully enclosed, and wherein the end wall includes a plurality of reinforcing ribs.

12. The thread protector of claim 11, wherein the length of the extended sidewall is between two and six times the length of the externally threaded collar.

13. The thread protector of claim 11, wherein the recessed socket is defined by four planar side walls and a rectangular end wall.

14. The thread protector of claim 11, wherein each of the plurality of reinforcing ribs extend radially toward a corner portion of the recessed socket.

15. The thread protector of claim 11, wherein the extended sidewall is frusto-conical and includes an outer diameter that narrows in the direction of the end wall.

16. The thread protector of claim 11, wherein the recessed socket is centrally disposed within the end wall.

17. The thread protector of claim 11, further including an intermediate sidewall disposed between the externally threaded collar and the circumferential flange.

18. The thread protector of claim 11, wherein the circumferential flange defines a maximum outer diameter of the thread protector.
